(19) United States
(12) Patent Application Publication
(10) Pub. No.: US 2007/0081486 A1
(43) Pub. Date: Apr. 12, 2007

(54) Wireless communication apparatus and control method therefor

(75) Inventor: Yuji Koide, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/543,061

(22) Filed: Oct. 5, 2006

(30) Foreign Application Priority Data
Oct. 12, 2005 (JP) 2005-298099

(51) Int. Cl. H04Q 7/00

(52) U.S. Cl. 370/328

(57) ABSTRACT

A wireless communication apparatus includes a USB communication unit that transmits data to and receives data from a computer via wired communication, a wireless communication unit, and a wireless communication with low power consumption unit that operates on low power. The wireless communication apparatus converts data received from the computer by wired communication and transmits the converted data to a digital camera by wireless communication, and converts data received from the digital camera by wireless communication and transmits the converted data to the computer by wired communication. The wireless communication apparatus detects the digital camera using the wireless communication with low power consumption unit and, if the digital camera is detected, communicates with the digital camera using the wireless communication unit.

### BACKGROUND OF THE INVENTION

1. Field of the Invention

The present invention relates to a wireless communication apparatus and a control method therefore, and more particularly, to a wireless communication apparatus and a control method therefor that enable wireless communication between a device that does not have a wireless communication function and a device that does have a wireless communication function, and realize power saving.

2. Description of the Related Art

Conventionally, connecting a computer and a digital camera using a USB (Universal Serial Bus) standard wired communication system and exchanging data is widely done. However, wired communication entails certain inconveniences, such as the trouble of connecting a cable, and, in the case of a portable device such as a digital camera, the need to carry around a cable together with the device. In addition, repeated connection and disconnection of the cable to a connector can damage the connector portion.

By contrast, in an effort to make the technology more convenient for the user, connecting the computer and the digital camera using wireless communication conforming to, for example the IEEE802.11b standard, and exchanging data between the computer and the digital camera is done. However, in this case, unless both the digital camera and the computer are equipped with a wireless communication function, wireless communication cannot be carried out.

A method of performing wireless communication using a USB-wireless conversion device when the computer is not equipped with a wireless communication function conforming to, for example, the IEEE802.11b standard is disclosed in JP-A-2004-86359. In this method, a USB-wireless conversion device is connected to a computer having a USB connector to establish IEEE802.11b-standard wireless communication between the USB-wireless conversion device and the digital camera, thus enabling communication between the computer and the digital camera to be carried out wirelessly.

In addition, in JP-A-2005-44094, using a data relay system for effecting a wireless communication between a USB host and a USB device to communicate wirelessly between a computer and a digital camera not equipped with a wireless communication function is proposed.

When using wireless communication of high communication rate conforming to, for example, IEEE802.11b or Bluetooth standard, the current consumption, although it depends on the performance of the wireless communication chip, must be in the order of approximately several hundred mA.

At the same time, with the USB standard, a cable and a connector equipped with two lines for power in addition to two lines for data signals are used. These USB power lines are present because the USB device that is connected to the USB receives a power supply of +5V from the computer or other device acting as a USB host. The devices are unable to consume an arbitrary amount of current; instead, current consumption is limited to one of the following three modes:
(1) Maximum current 100 mA or less power consumption mode
(2) Maximum current 500 mA or less power consumption mode
(3) Maximum current 500 μA or less suspended power consumption mode
   The maximum current 100 mA or less power consumption mode (1) specifies the current that the USB device can be supplied with from the USB host when the USB device is connected to the USB host. It is necessary for the USB device to operate in this power consumption mode until the USB device configuration is specified from the USB host. In other words, immediately after the USB device is connected to the USB host, a negotiation is executed between the USB host and the USB device in power consumption mode (1). In this negotiation, information concerning the configuration of the USB device is transmitted from the USB device to the USB host. A maximum power (MaxPower) field indicating the current value that the USB device requires after the USB device is configured is contained in this configuration data. If the USB host can supply the current specified by the MaxPower field as bus power, connection is permitted and configuring of the USB device is executed.

The maximum current 500 mA or less power consumption mode (2) becomes effective after the configuration of the USB device is specified. The USB device can operate in this power consumption mode after being configured.

The maximum current 500 μA or less suspended consumption mode (3) specifies the current that the USB device can be supplied with from the USB host when the computer or other device acting as the USB host shifts to a suspended state.

However, using a USB-wireless conversion device like that disclosed in JP-A-2004-86359, receiving a bus power supply from the USB host and connecting the USB-wireless conversion device and the digital camera by wireless communication has the following problems.

If the wireless communication standard is IEEE802.11b or Bluetooth, and particularly when exchanging data at high speed, the USB-wireless conversion device must receive a current supply of approximately several hundred mA from the USB host. As a result, the USB-wireless conversion device must be run in the maximum current 500 mA or less power consumption mode (2). At this time, assume that the USB-wireless conversion device is connected to a computer the IEEE802.11b or Bluetooth wireless communication function is rendered effective, and a wireless connection with the digital camera is attempted. At this time, even when the digital camera is not activated, the USB-wireless conversion device must continue to receive a supply of current of several hundred mA from the USB host.

In addition, in order for the USB device to receive a current supply of several hundred mA from the USB host, the USB host must execute configuring of the USB device. In so doing, the device such as a computer or the like that is the USB host internally loads a driver for the USB device connected, automatically activates an application set to launch, and so forth.

For example, the computer may be set to automatically activate image management software if it is detected that a digital camera is connected to the computer through a USB port. In this case, regardless of whether wireless communication has been established between the USB-wireless conversion device and the digital camera, when the USB host executes configuring of the USB-wireless conversion device, the image management software is activated on the computer. As a result, the user can become confused when the digital camera is not activated, or wireless communication with the digital camera is not established.

In addition, if USB communication between the USB host and the USB-wireless conversion device is carried out in a state in which the wireless communication between the USB-wireless conversion device and the digital camera has not been established, the following problems arise. Specifically, for example, when the camera name, file information or the like is requested by the USB host, since the USB-wireless conversion device must respond in place of the digital camera there can arise a discrepancy in the information between the USB host and the digital camera.

In addition, in the case of the method disclosed in JP-A-2004-86359, a plurality of types of information having different maximum power values is transmitted as configuration data from the USB device to the USB host, so as to reduce power consumption at the computer after configuring the USB device by controlling the USB device according to the configuration instructions permitted by the USB host according to this information.

However, the above-described method does not contemplate use in a state in which the device to be wirelessly connected is not activated. As a result, if the wireless communication means has been implemented using the IEEE802.11b standard, a state in which wireless communication is not established while several hundred mA of electric current is supplied from the USB host can continue for an extended period of time.

In addition, the above-described method cannot solve the problem that configuring of the USB device is executed from the USB host and an application on the computer that is the USB host is activated as a result, leading to confusion on the part of the user.

### SUMMARY OF THE INVENTION

The present invention has been made in consideration of the above-described situation, and has as a first object to reduce power consumption in a wireless communication apparatus that enables wireless communication between an apparatus that does not have a wireless communication function and an apparatus that does have a wireless communication function.

In addition, the present invention has as a second object to prevent discrepancies in information from arising between devices that communicate wirelessly via the wireless communication apparatus.

Further, the present invention has as a third object to prevent confusion on the part of a user due to the activation of an application running on one apparatus when wireless communication is not taking place via the wireless communication apparatus.

According to the present invention, the foregoing object is attained by providing a wireless communication apparatus that converts data received by wired communication from an external apparatus and transmits the converted data by wireless communication to an external wireless communication apparatus, and converts data received by wireless communication from the external wireless communication apparatus and transmits the converted data by wired communication to the external apparatus, the wireless communication apparatus comprising:

a transceiver unit that transmits data to and receives data from the external apparatus by wired communication;

a first wireless communication unit;

a second wireless communication unit that operates on power consumption lower than that of the first wireless communication unit; and

a control unit that controls to detect the external wireless communication apparatus using the second wireless communication unit and communicate with the external wireless communication apparatus using the first wireless communication unit if the external wireless communication apparatus is detected.

According to the present invention, the foregoing object is also attained by providing a wireless communication apparatus that converts data received by wired communication from an external apparatus and transmits the converted data by wireless communication to an external wireless communication apparatus, and converts data received by wireless communication from the external wireless communication apparatus and transmits the converted data by wired communication to the external apparatus, the wireless communication apparatus comprising:

a transceiver unit that transmits data to and receives data from the external apparatus by wired communication;

a wireless communication unit capable of operating in a first communication mode and in a second communication mode that operates on power consumption lower than that of the first communication mode; and

a control unit that controls the wireless communication unit to detect the external wireless communication apparatus in the second communication mode and communicate with the external wireless communication apparatus in the first communication mode if the external wireless communication apparatus is detected.

According to the present invention, the foregoing object is also attained by providing a control method for a wireless communication apparatus having a transceiver unit that transmits data to and receives data from the external apparatus by wired communication, a first wireless communication unit and a second wireless communication unit that operates on power consumption lower than that of the first wireless communication unit, the wireless communication apparatus converting data received by wired communication from an external apparatus and transmitting the converted data by wireless communication to an external wireless communication apparatus as well as converting data received by wireless communication from the external wireless communication apparatus and transmitting the converted data by wired communication to the external apparatus, the wireless communication apparatus control method comprising:

a detection step of detecting the external wireless communication apparatus using the second wireless communication unit; and

a control step of controlling to communicate with the external wireless communication apparatus using the first wireless communication unit if the external wireless communication apparatus is detected in the detection step.

According to the present invention, the foregoing object is also attained by providing a control method for a wireless communication apparatus having a transceiver unit that transmits data to and receives data from the external apparatus by wired communication and a wireless communication unit capable of operating in a first communication mode and in a second communication mode that operates on power consumption lower than that of the first communication mode, the wireless communication apparatus converting data received by wired communication from an external apparatus and transmitting the converted data by wireless communication to an external wireless communication apparatus as well as converting data received by wireless communication from the external wireless communication apparatus and transmitting the converted data by wired communication to the external apparatus, the wireless communication apparatus control method comprising:

a detection step of detecting the external wireless communication apparatus in the second communication mode; and

a control step of causing the wireless communication unit to detect the external wireless communication apparatus in the second communication mode and communicate with the external wireless communication apparatus in the first communication mode if the external wireless communication apparatus is detected.

Further features of the present invention will become apparent from the following description of exemplary embodiments (with reference to the attached drawings).

### BRIEF DESCRIPTION OF THE DRAWINGS

FIG. 1 is a block diagram showing one configuration of a communication system according to an embodiment of the present invention;

FIG. 2 is a block diagram showing another configuration of the communication system according to an embodiment of the present invention;

FIG. 3 is a block diagram showing the overall configuration of mainly a wireless communication apparatus and a digital camera in a communication system according to a first embodiment of the present invention;

FIG. 4 is a diagram of an IEEE802.11b-standard packet structure;

FIGS. 5A, 5B and 5C are diagrams showing PTP transaction formats;

FIGS. 6A, 6B and 6C are packet structure diagrams showing a PTP operation phase packet, data phase packet and response phase packet, respectively;

FIG. 7 is a flow chart illustrating wireless communication connection and disconnection in the wireless communication apparatus according to the first embodiment of the present invention;

FIG. 8 is a flow chart illustrating wireless communication connection and disconnection in the digital camera according to the first embodiment of the present invention;

FIGS. 9A and 9B are diagrams showing the configuration of USB Still Image class descriptor information;

FIG. 10 is a block diagram showing the overall configuration of mainly a wireless communication apparatus and a digital camera in a communication system according to a second embodiment of the present invention;

FIG. 11 is a flow chart illustrating wireless communication connection and disconnection in the wireless communication apparatus according to the second embodiment of the present invention; and

FIG. 12 is a flow chart illustrating wireless communication connection and disconnection in the digital camera according to the second embodiment of the present invention.

### DESCRIPTION OF THE EMBODIMENTS

Preferred embodiments of the present invention will now be described in detail in accordance with the accompanying drawings.

### First Embodiment

First, a wireless communication apparatus according to a first embodiment of the present invention will be described with reference to the drawings.

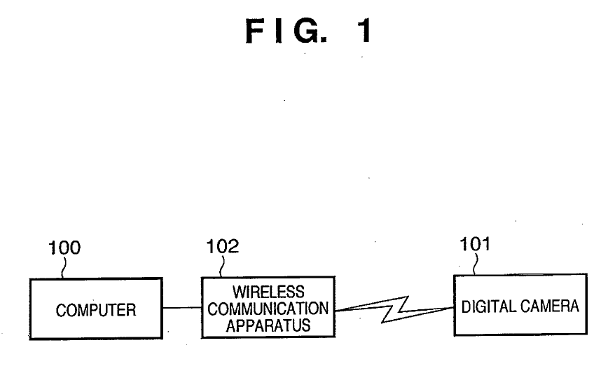

FIG. 1 is a block diagram showing one configuration of a wireless communication system of the present invention. The wireless communication system shown in FIG. 1 is comprised of a computer 100, a digital camera 101 and a wireless communication apparatus 102.

The wireless communication apparatus 102 is connected to the computer 100 by a USB-standard communication system, with communication implemented by the wireless communication apparatus 102 functioning as a USB device and the computer 100 functioning as a USB host. The wireless communication apparatus 102 and the digital camera 101 are each equipped with an IEEE802.11b-standard wireless communication unit.

The wireless communication apparatus 102 is equipped with the capability, when it receives a USB-standard data packet sent from the computer 100, to convert that data packet into an IEEE802.11b-standard wireless data packet and transmit it to the digital camera 101. Further, the wireless communication apparatus 102 is also equipped with the capability, when it receives an IEEE802.11b-standard wireless data packet sent from the digital camera 101, to convert that data packet into a USB-standard data packet and transmit it to the computer 100. In this manner, the wireless communication apparatus 102 that can communicate wirelessly with the digital camera 101 is USB-connected to the computer 100, thus enabling implementation of wireless communication with the digital camera 101 even when the computer 100 is not equipped with an IEEE802.11b-standard wireless communication unit.

Further, in the first embodiment of the present invention, the wireless communication apparatus 102 and the digital camera 101 are equipped with ZigBee-specification wireless communication units. The ZigBee specification is a short-range, wireless communication standard for household electric appliances, and although it has a lower data transfer rate and a shorter maximum transmission distance than either IEEE802.11b or Bluetooth standards, it has the advantages of low power consumption and low cost. Although varying depending on the controller and the control method, devices based on the ZigBee specification can operate with currents as low as approximately 10-20 mA when sending and receiving data. It should be noted that, in the ZigBee specification, the maximum data transmission speed is 250 kbps, and the maximum transmission range is approximately 30 m.

It should be noted that, in the following description, in order to make a distinction with ZigBee-specification wireless communication function with low power consumption, the wireless communication function based on the IEEE802.11b standard is also called a high speed wireless communication function. It should be noted that “high speed” here simply means a data transfer rate that is faster than wireless communication with low power consumption (here, the ZigBee specification), and is not specifically limited numerically.

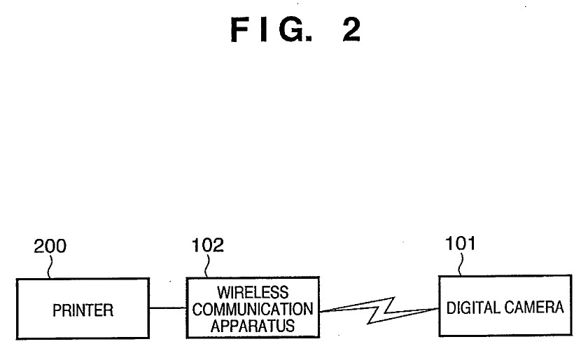

FIG. 2 is a block diagram showing another configuration of the wireless communication system of the present invention. In FIG. 2, a printer 200 is connected in place of the computer 100 of the wireless communication system shown in FIG. 1. The wireless communication apparatus 102 is connected to the printer 200 by USB-standard communication and used. In this case, communication is implemented by the wireless communication apparatus 102 acting as the USB device, and the printer 200 as the USB host.

Conventionally, a system that connects a printer and a digital camera directly by USB to realize so called “direct print” has been proposed. The printer 200 is assumed to be equipped with this direct print function. In addition, the wireless communication apparatus 102, as described above, has the ability to convert wireless data packets based on the IEEE802.11b standard into USB-standard data packets and vice-versa. Consequently, even if the printer is not provided with a wireless communication unit based on the IEEE802.11b standard, it becomes possible to implement a direct print function by wireless communication between the digital camera 101 and the printer 200.

It should be noted that, in the first embodiment, the printer 200 is also equipped with a ZigBee-specification wireless communication unit.

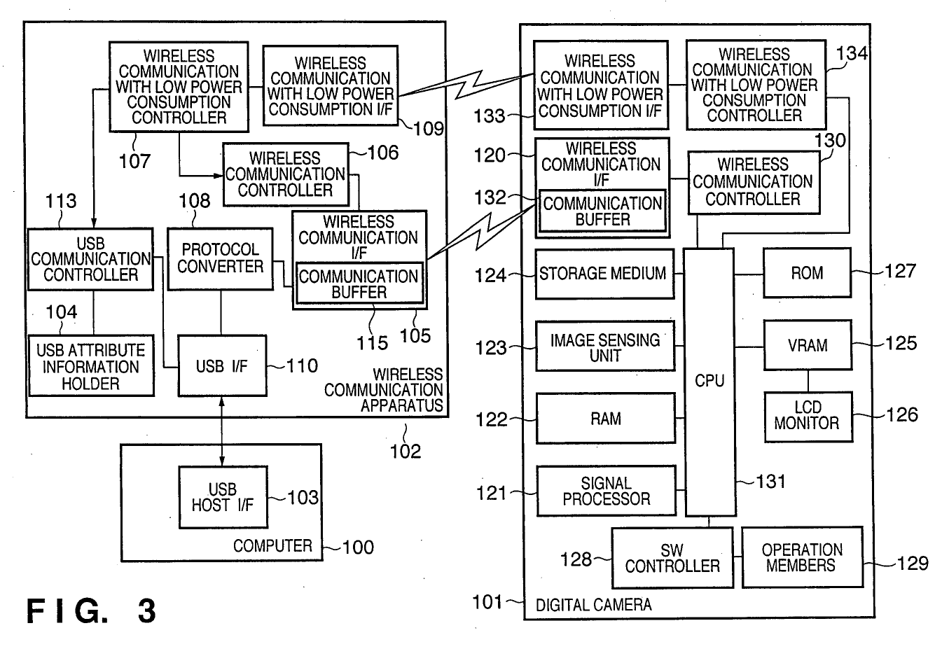

FIG. 3 is a block diagram showing the overall configuration of mainly a wireless communication apparatus 102 and a digital camera 101 in a communication system according to the first embodiment of the present invention. It should be noted that, here, a wireless communication system having the configuration shown in FIG. 1 is treated as one example and a detailed description is now given of processing in such a configuration.

The wireless communication apparatus 102 is provided with a USB I/F 110 and is connected by USB-standard communication to the computer 100 through a USB HOST I/F 103 of the computer 100. The wireless communication apparatus 102 operates on power supplied from the computer 100 through the USB I/F 110, and as a result does not require a battery or other power supply means.

A USB communication controller 113 that is the controller for the USB I/F 110 is connected to the USB I/F 110. The USB communication controller 113 is equipped with a function that, depending on the values of the USB attribute information stored in a USB attribute information holder 104, generates data defined by USB standard and responds to requests from the USB host. The data defined by USB standard includes Device Descriptor as well as Device Qualifier Descriptor and Configuration Descriptor, and also includes Other Speed Configuration Descriptor, Interface Descriptor and Endpoint Descriptor.

In addition, the wireless communication apparatus 102 is equipped with a wireless communication I/F 105 and can carry out IEEE802.11b-standard wireless communication with the digital camera 101 via the wireless communication I/F 120 of the digital camera 101. A wireless communication controller 106 that controls the wireless communication I/F 105 is connected to the wireless communication I/F 105.

The wireless communication apparatus 102 is provided with a protocol converter 108. A description is now given of the operation of the protocol converter 108.

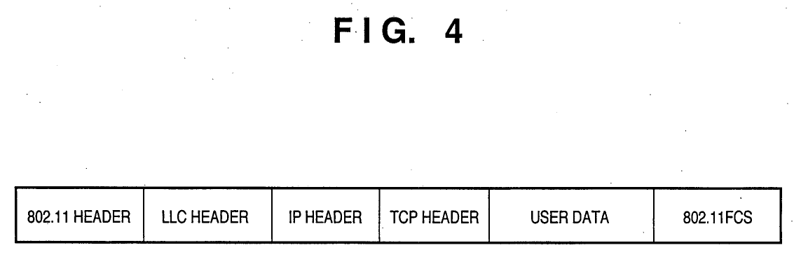

FIG. 4 is a diagram showing the packet structure of an IEEE802.11b-standard wireless data packet exchanged between the wireless communication apparatus 102 and the digital camera 101.

As the method for communicating with the digital camera 101, the wireless communication apparatus 102 of the first embodiment uses a method in which, after the user data is converted into a TCP/IP-format packet and the TCP/IP-format packet is then converted into an IEEE802.11b-standard packet that is then transmitted and received by wireless communication. As a result, a TCP header, IP header, LLC header (logic link control field) and an 802.11 header are added at the head of the user data, and 802.11FCS (frame error check field) is added after the user data. A data packet in a format determined by PTP (Picture Transfer Protocol) is contained as the user data.

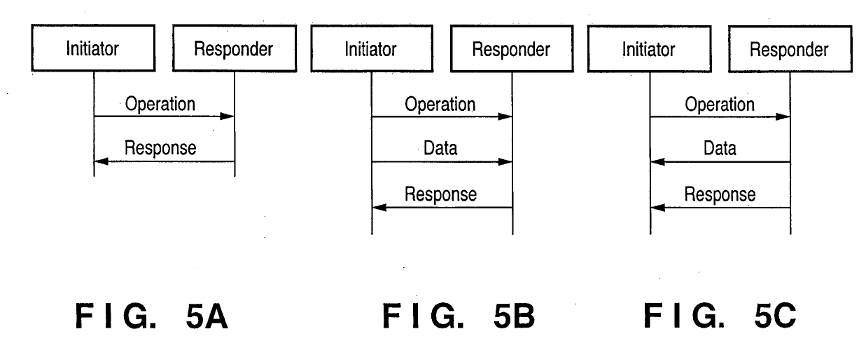

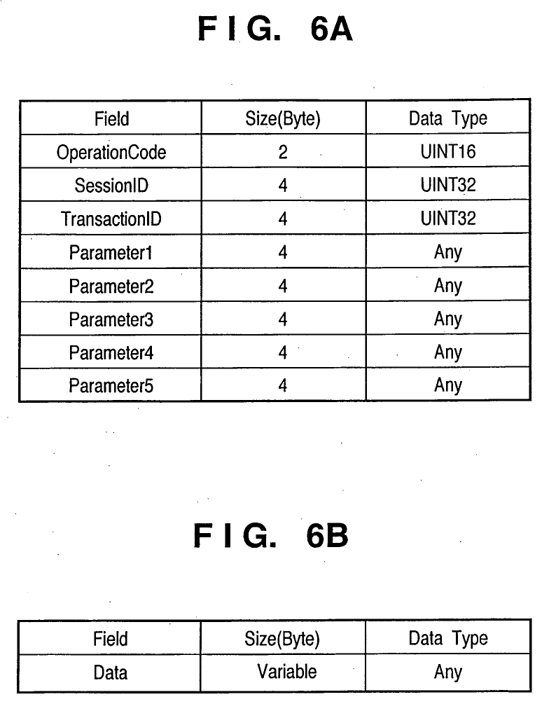

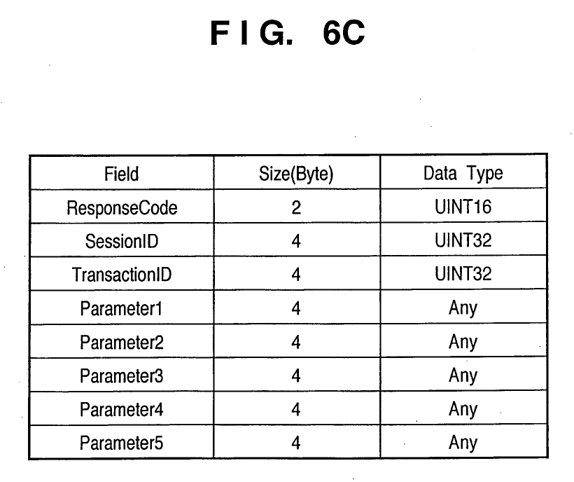

FIGS. 5A-5C show the format of the transactions that take place between Initiator and Responder in PTP. In addition, FIG. 6A shows the structure of an operation phase packet, FIG. 6B shows the structure of a data phase packet and FIG. 6C shows the structure of a response phase packet, respectively.

In PTP, transactions with the structure of operation phase→response phase shown in FIG. 5A and transactions with the structure of operation phase→data phase→response phase as shown in FIGS. 5A and 5B are defined. In the data phase, there is transmission of data from the Initiator to the Responder as shown in FIG. 5B and transmission of data from the Responder to the Initiator as shown in FIG. 5C.

When putting a PTP data packet into the wireless data packet structure shown in FIG. 4, the PTP data packet is divided into sizes each fits into one TCP packet, after which appropriate headers are added and the each divided data packet with headers is written to the user data area.

When an IEEE802.11b-standard data packet transmitted from the digital camera 101 is received at the wireless communication I/F 105, first, the headers and so forth that are defined by the IEEE802.11b standard are removed. Then, further, in accordance with the IP header and the TCP header, the user data is extracted and sequentially accumulated in a communication buffer 115 built in the wireless communication I/F 105.

The protocol converter 108, as described above, extracts the accumulated user data from the wireless communication I/F 105. Then, the PTP data phase packet and response phase packet are constructed by operation of a conversion program that is executed by the protocol converter 108. The PTP data phase packet and response phase packet are further converted to a USB-standard data packet, transferred to the USB I/F 110 and transmitted to the computer 100. It should be noted that, when transmitting PTP data packets in a USB-standard communication system, USB Bulk In transfer is used.

At the same time, in the wireless communication apparatus 102, when a PTP data packet is received in USB-based communication, USB Bulk Out transfer is used. When USB-standard data packets are transmitted from the computer 100, they are received at the USB I/F 110 and from among the received USB data packets a standard request packet is handled by the USB communication controller 113. The PTP data packets are input to the protocol converter 108. The protocol converter 108 operates to divide the PTP operation phase packet and data phase packet, converts them to TCP/IP user data format and transfers them to the wireless communication I/F 105. The wireless communication I/F 105 accepts the TCP/IP user data, adds a TCP header, an IP header and further an LLC header, 802.11 header and 802.11FCS and generates an IEEE802.11b-standard data packet. The data packet thus generated is then transmitted to the digital camera 101 by wireless communication.

Thus, as described above, the computer 100 can communicate with the digital camera 101 equipped with the wireless communication I/F 120. It should be noted that the computer 100 can implement this communication with the digital camera 101 through the same operation of hardware and software as when directly connecting a USB device to the USB host I/F 103 and exchanging PTP data packets. In other words, the functioning of the wireless communication apparatus 102 enables a user of the computer 100 to execute the same digital camera operation applications as when a USB device is connected to the computer.

In addition, the wireless communication apparatus 102 of the first embodiment is provided with a wireless communication with low power consumption I/F 109, and carries out ZigBee-specification wireless communication with the digital camera 101 through a wireless communication with low power consumption I/F 133 of the digital camera 101. A wireless communication with low power consumption controller 107 that is the controller for the wireless communication with low power consumption I/F 109 is connected to the wireless communication with low power consumption I/F 109.

Communication using the wireless communication with low power consumption I/F 109 is mainly carried out when the wireless communication apparatus 102 and the digital camera 101 each detect the existence of the other. In other words, when the wireless communication apparatus 102 searches for the digital camera 101 on a wireless network, or conversely, when the digital camera 101 searches for the wireless communication apparatus 102 on a wireless network, wireless communication with low power consumption is used. Particularly when the wireless communication apparatus 102 is connected to the computer 100 or to the printer 200, searching over an extended period of time until a wireless connection is established based on the IEEE802.11b standard can happen. By using wireless communication with low power consumption, power consumption can be reduced.

The digital camera 101 is provided with an image sensing unit 123. The image sensing unit 123 is comprised of an image sensing lens, an image sensing element typified by a CCD or CMOS sensor that receives light from a subject entering via the image sensing lens and photoelectrically converts that light to generate image signals, an analog/digital (A/D) converter disposed distal of the image sensing element and so forth. Under the control of a CPU 131, the image sensing unit 123 outputs a digital image signal, the signal is processed by a signal processor 121 and a digital image signal is then temporarily stored in a RAM 122. Thereafter, image sensing setting information is added to the header area of the digital image signal thus created as attribute information and the signal ultimately is saved as an image file on a storage medium 124 such as a compact flash (registered trademark).

It should be noted that the storage medium 124 for saving the image file may also be of any type, such as a memory card other than a compact flash (registered trademark) memory, a magneto-optic disk, or some other removable media.

To the CPU 131 are further connected a ROM 127, a SW controller 128 that controls input from a variety of operation members 129, and a VRAM 125 for holding digital image signal display data, various user interface display data and the like. It should be noted that the contents of the display data held in the VRAM 125 are displayed on an LCD monitor 126. In addition, a wireless communication controller 130 that is the controller for the wireless communication I/F 120 and a wireless communication with low power consumption controller 134 that is the controller for the wireless communication with low power consumption I/F 133 are also connected to the CPU 131.

Programs for sensing an image as well as programs for displaying sensed images on the LCD monitor 126 are held in the ROM 127. In addition, programs for communicating, such as acquiring and interpreting user data received from the wireless communication I/F 120, and generating transmission data and writing it to the wireless communication I/F 120, are also held in the ROM 127.

As the various operation members 129 there are, for example, a power switch for turning the power ON/OFF, a release switch for instructing image sensing, a switch for instructing display of a digital image signal on the LCD monitor 126 and so forth. In addition, there is a switch for displaying a menu on the LCD monitor 126, switches used for forwarding or reversing an image frame and changing the selection of a menu, a touch panel for inputting instructions directly on the LCD, switches for instructing the start/stop of wireless communication, and so forth.

When an IEEE802.11b-standard data packet transmitted from the wireless communication apparatus 102 is received at the wireless communication I/F 120 of the digital camera 101, the header and so forth defined by the IEEE802.11b standard is removed. Then, further, the user data is extracted according to the IP header and the TCP header and sequentially accumulated in the communication buffer 132 that is built in the wireless communication I/F 120.

As the user data that is accumulated in the communication buffer 132 within the wireless communication I/F 120 there is PTP operation phase data, data phase data and the like transmitted via the wireless communication apparatus 102 from the computer 100. The digital camera 101 of the first embodiment, by the operation of a communication program held in the ROM 127, first extracts the accumulated user data from the wireless communication I/F 120, and then constructs and interprets the PTP operation phase packet and data phase packet.

Similarly, by operation of the communication program, the digital camera 101 generates a data phase packet and a response phase packet to be transmitted to the computer 100 according to the accepted PTP operation phase packet and writes them to the communication buffer 132. The wireless communication I/F 120 divides the written PTP operation phase packet and data phase packet, adds to each divided packet a TCP header and an IP header, and further adds an LLC header, 802.11 header and 802.11FCS, thus generating IEEE802.11b-standard data packets and transmitting them to the wireless communication apparatus 102 by wireless communication.

Next, communication control of the first embodiment in the wireless communication system having the configuration described above will be described.

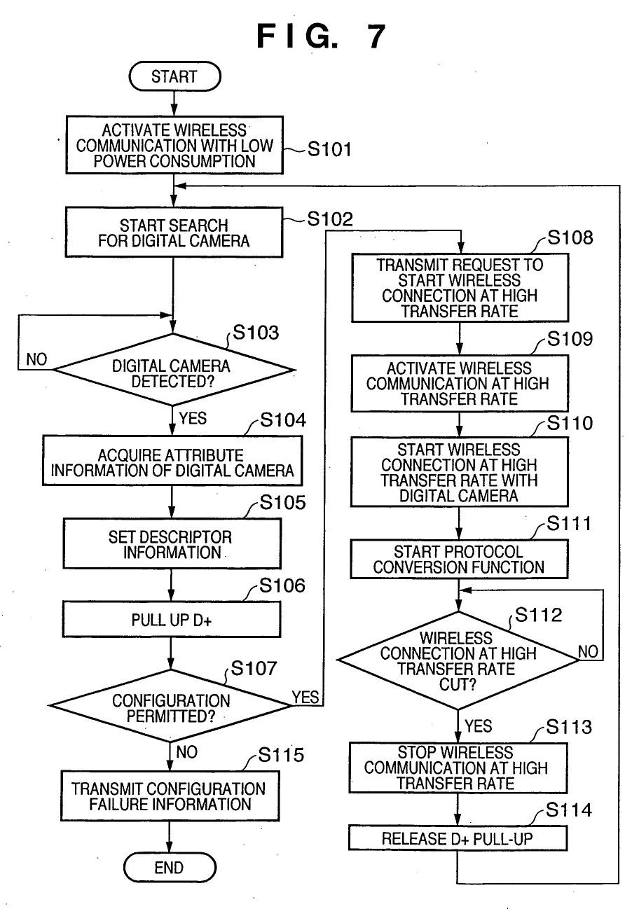

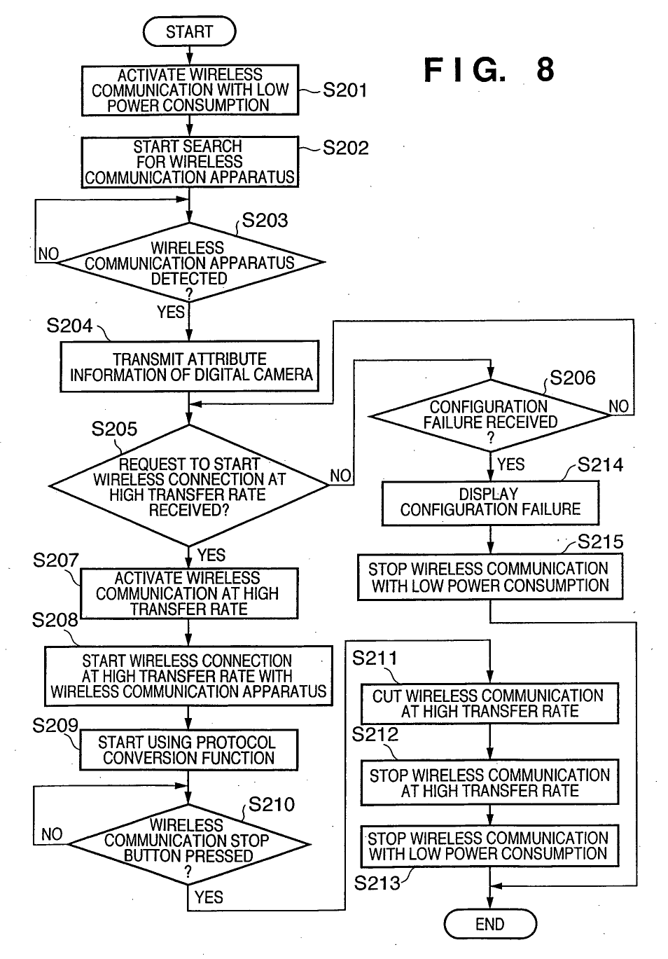

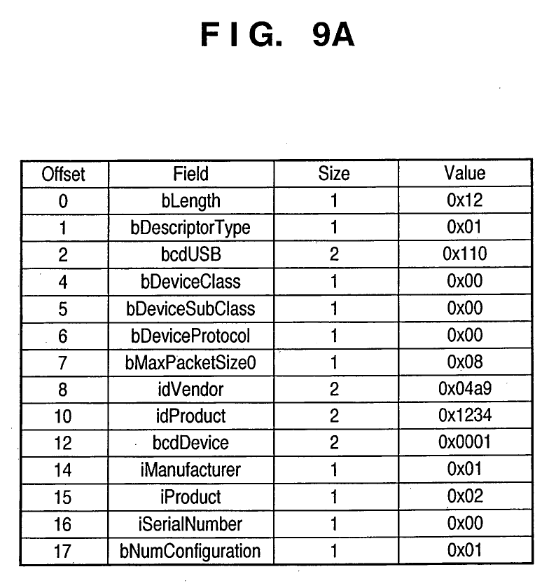

FIGS. 7 and 8 are flow charts showing wireless communication connection and disconnection sequences in the wireless communication apparatus 102 and the digital camera 101, respectively.

First, a wireless communication connection and disconnection sequence in the wireless communication apparatus 102 will be described, with reference to FIG. 7.

When the USB I/F 110 is connected to the USB I/F 103 of the computer 100, the wireless communication apparatus 102 of the present embodiment detects voltage across the USB terminal V-bus and starts to operate. The wireless communication apparatus 102 operates with a supply of power of +5V from the USB host.

As described above, until the configuration (Enable function) of the USB device is specified from the USB host, the wireless communication apparatus 102 must operate in a power consumption mode of maximum current 100 mA or less. In the first embodiment, the wireless communication apparatus 102 starts ZigBee communication, which is a wireless communication with low power consumption function using the wireless communication with low power consumption I/F 109 (step S101), and starts to search for the digital camera 101 (step S102). The search for the digital camera 101 can be carried out by repeatedly transmitting at regular intervals some sort of signal from the wireless communication apparatus 102 and determining whether or not there is a response thereto. Alternatively, this search can also be implemented by the digital camera 101 continuously transmitting a beacon signal that is monitored at regular intervals.

In ZigBee-specification wireless communication, the devices involved can operate on currents of approximately 10-20 mA when communicating. In addition, during the search for the digital camera 101, clock supply to the wireless communication I/F 105, the wireless communication controller 106, the protocol converter 108 and the USB communication controller 113 is stopped. Therefore, provided that the search operation is carried out intermittently, the search for the digital camera 101 can be conducted using power consumption that is on average approximately several mA, thus enabling-power consumption to be reduced.

In particular, although the wireless communication apparatus 102 may be left in a state of connection to the computer 100 for an extended period of time, in that case, the effect of reducing consumption of the battery of the computer 100 consumed by the search for the digital camera 101 is especially great.

If the existence of the digital camera 101 is detected (YES in step S103), the wireless communication apparatus 102 acquires the attribute information of the digital camera 101 through the wireless communication with low power consumption I/F 109 (step S104). Then, based on the attribute information acquired in step S104, the wireless communication apparatus 102 sets the USB descriptor information (step S105). The descriptor information contains information indicating the type of device defined by USB standard (the device class), the device name, Product ID, power consumption information and the like. Thus, by setting the descriptor information based on the attribute information of the digital camera 101 acquired using wireless communication with low power consumption, it is possible to load the appropriate driver in the computer 100 to which the wireless communication apparatus 102 is USB-connected. In addition, the correct digital camera name can be displayed to the user.

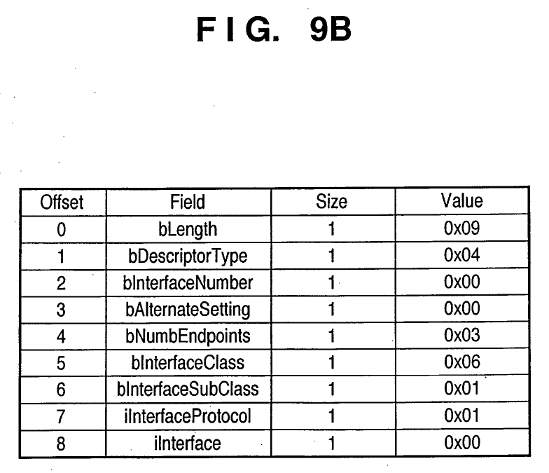

It should be noted that, in the present embodiment, when the wireless communication apparatus 102 acquires the attribute information of the digital camera 101, it sets a USB Still Image class device descriptor. FIG. 9A shows an example of the configuration of Still Image class device descriptor information and FIG. 9B shows an example of the configuration of interface descriptor information. In the case of a Still Image class device, the bInterfaceClass=0×06, bInterfaceSubClass=0×01, and bInterfaceProtocol=0×01. In other words, after the digital camera 101 is detected, the wireless communication apparatus 102 behaves like a USB Still Image class device to the computer 100.

Next, after starting clock supply to the USB communication controller 113, one of the USB signal lines (the D− signal line for a Low Speed device or the D+ signal line for a Full Speed device) is pulled up to 3.3V (step S106). This operation causes the computer 100, which is the USB host, to recognize the wireless communication apparatus 102 and start USB communication. In USB communication, first, a negotiation is executed between the computer 100, which is the USB host, and the wireless communication apparatus 102, which is the USB device.

In this negotiation, information relating to the USB device configuration (functional structure) is transmitted from the USB device to the USB host and the USB host determines whether or not to permit USB connection with that configuration. If as a result of that determination connection is permitted, the USB device configuration is specified from the USB host. The configuration data contains a required current value information (MaxPower) field showing the amount of current that the USB device requires during normal operation. With the wireless communication apparatus 102 of the first embodiment, 500 mA is written as the MaxPower field-value. After the configuration is specified from the USH host, the wireless communication apparatus 102 activates the wireless communication I/F 105 and carries out IEEE802.11b-standard wireless communication with the digital camera 101, as a result of which, after the digital camera 101 is detected, several hundred mA of current is uninterruptedly supplied from the USB host.

If a configuration failure instruction (that is, the configuration value is zero) is generated from the USB host (NO in step S107), that information is transmitted to the digital camera 101 through the wireless communication with low power consumption I/F 109 (step S115). The digital camera 101 takes this information and displays it on the LCD monitor 126 as configuration failure information or the like, enabling the user to be notified of a connection failure.

On the other hand, if a configuration instruction (that is, the configuration value is an appropriate value other than zero) is generated from the USB host (YES in step S107), the sequence proceeds to step S108. In step S108, using the wireless communication with low power consumption I/F 109, an IEEE802.11b-standard wireless communication start request is transmitted to the digital camera 101. In addition, clock supply to the wireless communication I/F 105, the wireless communication controller 106 and the protocol converter 108 is started, and further, in step S109, IEEE802.11b-standard wireless communication at high transfer rate is started.

In order to conduct IEEE802.11b-standard wireless communication at high transfer rate, the wireless communication settings of the wireless communication apparatus 102, such as the wireless channel to be used, the ESS-ID, WEP Key or the like, must be same as those for the digital camera 101 that is the connection partner. In the first embodiment, between the wireless communication apparatus 102 and the digital camera 101, these wireless settings are set the same in advance. The wireless communication apparatus 102 is assumed to be capable of retaining the wireless setting information, so that, no matter to which computer the wireless communication apparatus 102 is attached, there is no need to match the wireless settings of the digital camera 101 to the settings of the wireless network to which that computer belongs. Therefore, such an arrangement has the advantage of enabling wireless connection between the digital camera 101 and any given computer by USB-connecting the wireless communication apparatus 102 to the computer.

It should be noted that, with the configuration specification from the USB host in step S107, the wireless communication apparatus 102 starts to behave like a Still Image class USB device toward the computer 100. In response, at the computer 100 a Still Image class driver is loaded into the memory. Further, if launch application is set, an application set to launch, such as an image capturing application or an image viewer application, is automatically activated on the computer 100.

The Still Image class driver is installed in the Windows OS and Mac OS when shipped, and therefore the user can use the driver without having to install it.

Thus, as described above, in the computer 100, when the Still Image class driver is loaded into the memory and a predetermined application is automatically activated on the computer 100, the wireless communication apparatus 102 has already detected the digital camera 101. Therefore, when an instruction to start wireless communication is provided by the user in the digital camera 101 and wireless communication between the wireless communication apparatus 102 and the digital camera 101 is established, it appears as if the application activates automatically on the computer 100. As a result, automatic activation of an application despite the fact that a wireless connection between the digital camera 101 and the wireless communication apparatus 102 is not being effected disappears, thus eliminating a sense of incongruity in operability on the part of the user.

Next, when the computer 100 that is the USB host carries out configuration specification, the operation of the Still Image class driver generates a PTP operation. The wireless communication apparatus 102 retains the received PTP operation phase data internally and, after starting a conversion program in step S111 that is described later, transmits the PTP operation phase data to the digital camera 101.

In step S110, the wireless communication apparatus 102 starts IEEE802.11b-standard wireless connection at high transfer rate with the digital camera 101, and further, in step S111, starts execution of the conversion program. At this stage, the digital camera 101 and the computer 100 are connected via the wireless communication apparatus 102. When viewed from the digital camera 101, it appears to be communicating with the computer 100 by IEEE802.11b-standard wireless communication at high transfer rate. By contrast, when viewed from the computer 100, it appears as if a Still Image class USB device is connected to the USB host I/F 103, with which it exchanges data packets in a format that is determined by PTP.

Specifically, in accordance with the PTP operation phase data that is sent from the computer 100, the digital camera 101 transmits and receives data phase data, transmits response data, and so forth, enabling image data stored on the storage medium 124 of the digital camera 101 to be transmitted to the computer 100, and conversely, enabling image data sent from the computer 100 to be saved on the storage medium 124.

In step S111, when a protocol conversion function is executed, monitoring to determine whether or not wireless connection at high transfer rate has been cut is started in step S112. If the wireless connection at high transfer rate has been cut, then in step S113 the IEEE802.11b-standard wireless communication at high transfer rate function is stopped and the wireless communication apparatus 102 once again returns to a state of operating only the wireless communication with low power consumption function. Further, in step S114 the pulled up state on the D+ signal line is released and the USB connection with the computer 100 is cut, after which the sequence returns to the state of step S102.

In this state, the wireless communication apparatus 102, using ZigBee-specification wireless communication, which is the wireless communication with low power consumption function, recommences the search for the digital camera 101, and returns to the state of receiving a supply of approximately several mA of current on average from the computer 100 that is the USB host.

In addition, when viewed from the computer 100 to which the wireless communication apparatus 102 is connected, the digital camera 101 appears to be disconnected from the USB bus and there appears to be no USB device connected to the USB bus.

Next, a wireless communication connection and disconnection sequence in the digital camera 101 will be described, with reference to FIG. 8.

The sequence shown in FIG. 8 is started, for example, by the user instructing the start of wireless communication using the operation members 129 of the digital camera 101.

First, in step S201, the digital camera 101 starts the ZigBee-specification communication that is the wireless communication with low power consumption, and in step S202 starts searching for the wireless communication apparatus 102 using wireless communication with low power consumption. The search for the wireless communication apparatus 102, like the search operation that is carried out by the wireless communication apparatus 102, can be implemented by repeatedly transmitting at regular intervals some sort of signal from the digital camera 101 and determining whether or not there is a response thereto. Alternatively, this search can also be implemented by the wireless communication apparatus 102 continuously transmitting a beacon signal that is monitored at regular intervals.

If the existence of the wireless communication apparatus 102 is detected (YES in step S203), the attribute information of the digital camera 101 is transmitted to the wireless communication apparatus 102 using wireless communication with low power consumption (step S204).

Thereafter, in step S205, the wireless communication apparatus 102 waits for a request to start IEEE802.11b-standard wireless communication with high power consumption to be transmitted from the digital camera 101 on the wireless communication with low power consumption transmission path. It should be noted that, while waiting for the wireless communication at high transfer rate start request (specifically, as long as NO in step S205), in step S206 it is determined whether or not configuration failure information has been transmitted from the digital camera 101.

If in step S206 configuration failure information is received, in step S214 the failure of the configuration is displayed on the LCD monitor 126 of the digital camera 101 so as to notify the user. Further, in step S215 wireless communication with low power consumption is stopped and the wireless connection sequence is ended. It should be noted that one cause of configuration failure can be insufficient power supply capacity on the part of the computer 100 to which the wireless communication apparatus 102 is connected. If matters are arranged so that such information is displayed as the cause of failure, then the user can take appropriate action, such as switching the computer 100 from battery power to AC power or the like.

On the other hand, when in step S205 a request to start wireless communication at high transfer rate is received from the digital camera 101, then in step S207 IEEE802.11b-standard wireless communication at high transfer rate is started. In order to conduct IEEE802.11b-standard wireless communication at high transfer rate, the wireless communication settings of the digital camera 101, such as the wireless channel to be used, the ESS-ID, WEP Key or the like, must be same as those for the wireless communication apparatus 102 that is the connection partner. In the first embodiment, as described above, between the wireless communication apparatus 102 and the digital camera 101 these settings are set the same in advance. In addition, the digital camera 101 is assumed to be capable of retaining wireless setting information.

The sequence next proceeds to step S208, in which a connection with the wireless communication apparatus 102 at IEEE802.11b-standard wireless communication at high transfer rate is started. In step S209, the digital camera 101 starts to use the protocol conversion function that the wireless communication apparatus 102 provides.

In this state, if the user operates the operation members 129 of the digital camera 101 to specify image transmission and instruct transmission, the specified image file can be transmitted to the computer 100 through the wireless communication apparatus 102.

In addition, by the user operating the computer 100, image files can be transmitted and received between the digital camera 101 and the computer 100 through the wireless communication apparatus 102. Specifically, between the digital camera 101 and the wireless communication apparatus 102, PTP data packets are loaded onto TCP payloads and further converted to IEEE802.11b-standard packets for transmission and reception by wireless communication.

Inside the digital camera 101, once an IEEE802.11b-standard packet sent from the wireless communication apparatus 102 is received, the header and so forth as defined by IEEE802.11b standard is removed. Further, in accordance with the IP header and the TCP header, the user data is extracted, and finally, the PTP operation phase data and data phase data are extracted and processed. On the other hand, when PTP data phase data and response phase data are transmitted from the digital camera 101, the PTP data packet is divided into sizes each fits into a single TCP packet, after which appropriate headers are attached. Further, the each divided packet with headers is converted into an IEEE802.11b-standard packet and transmitted by wireless communication.

While the digital camera 101 is using the protocol conversion function that the wireless communication apparatus 102 provides, in step S210 there is monitoring of the user pressing the power button or the wireless communication end button of the operation members 129. If the user presses the power button or the wireless communication end button, in step S211 the wireless connection at high transfer rate is cut and in step S212 the IEEE802.11b-standard wireless communication at high transfer rate function is stopped. Further, in step S213 the wireless communication with low power consumption function is stopped and the wireless communication sequence is ended.

Thus, as described above, according to the first embodiment, except while the IEEE 802.11-standard wireless communication at high transfer rate between the digital camera 101 and the wireless communication apparatus 102 is being conducted, wireless communication with low power consumption is conducted, thus enabling power consumption at the wireless communication apparatus 102 to be reduced.

In addition, with the wireless communication apparatus 102 of the first embodiment, the wireless communication with low power consumption I/F 109 and the wireless communication with low power consumption controller 107 are separate from the wireless communication I/F 105 and the wireless communication controller 106.

Therefore, the wireless communication with low power consumption I/F 109 and the wireless communication with low power consumption controller 107 can be configured as a single chip, and the wireless communication I/F 105, the wireless communication controller 106, the USB communication controller 113, protocol converter 108 and so forth can be configured as the main CPU or as an RF chip or the like. Such a configuration enables the wireless communication apparatus 102 to operate on only a wireless communication chip with low power consumption while searching for the digital camera 101. Once the digital camera 101 is found, the wireless communication chip with low power consumption can activate the main CPU, thus enabling power consumption during the search for the digital camera 101 to be reduced.

In addition, the wireless communication apparatus 102, after it detects the existence of the digital camera 101, acquires the attribute information of the digital camera 101 using wireless communication with low power consumption and sets the USB descriptor information based on the attribute information thus acquired. In addition, after connection using IEEE802.11b-standard wireless communication is started and the conversion program is executed, PTP data packets are transmitted from the computer 100 to the digital camera 101, and from the digital camera 101 to the computer 100. As a result, it is not necessary for the wireless communication apparatus 102 to respond in place of the digital camera 101 or to reply with temporary information to requests in the form of PTP data packets or USB data packets from the USB host, and therefore discrepancies in the information exchanged between the USB host and the digital camera 101 can be prevented from occurring.

The wireless communication apparatus 102 of the first embodiment is equipped with a ZigBee-specification communication unit as a wireless communication with low power consumption. Alternatively, however, in place of ZigBee, for example, IrDA (IrBUS) may be used. IrBUS, in addition to having low power consumption like ZigBee, also has good directionality because it uses infrared light. Therefore, when the user wishes to start a wireless connection, he or she points the digital camera 101 at the wireless communication apparatus 102 and issues an instruction. Such an arrangement has the advantage that, in this case, an IEEE802.11b-standard wireless communication connection can be established with a target device even in an environment in which there exists a plurality of wireless communication apparatuses.

Although the wireless communication at high transfer rate between the wireless communication apparatus 102 and the digital camera 101 of the first embodiment is described in terms of an embodiment using IEEE802.11b-standard wireless communication, the present invention is not limited thereto. Thus, for example, the present invention can be implemented by replacing the IEEE802.11b-standard wireless communication at high transfer rate with Bluetooth, or with the even faster IEEE802.11g- or IEEE802.11n-standard wireless communication.

Further, although in the first embodiment the wired communication function between the wireless communication apparatus 102 and the computer 100 is implemented as USB-standard wired communication, it is of course possible to use wired communication that conforms to other wired communication standards instead.

In addition, in the first embodiment described above, the example of a system composed of the computer 100 that does not have a wireless communication function, the wireless communication apparatus 102 and the digital camera 101 that does have a wireless communication function is used. However, the present invention is not limited to such an arrangement, and it is of course possible to use any device that does not have a wireless communication function in place of the computer 100, as well as any device that does have a wireless communication function in place of the digital camera 101.

For example, if the wireless communication apparatus 102 of the first embodiment is connected to the printer 200, the printer 200 can be controlled as follows: After it is detected that a USB device has been attached to the USB host terminal, the circuits and parts for executing a print, as well as the circuits and so forth for conducing USB communication, are activated. According to the wireless communication apparatus 102 of the first embodiment, while searching for the digital camera 101 the D+ signal line is not pulled up, and therefore the printer 200, which is the USB host, is not allowed to recognize the wireless communication apparatus 102. Consequently, since the search for the digital camera 101 can continue for an extended period of time, power consumption on the printer 200 side during that time can be effectively reduced.

In addition, in the first embodiment, in the wireless communication apparatus 102 and the digital camera 101, even after the start of the IEEE802.11b-standard wireless communication at high transfer rate function in step S109 and step S207, the wireless communication with low power consumption function remains in effect. Therefore, when not exchanging PTP data packets between the wireless communication apparatus 102 and the digital camera 101 using IEEE802.11b-standard wireless communication at high transfer rate for an extended period of time, matters may be arranged as follows: When not exchanging PTP data packets for an extended period of time, the IEEE802.11b-standard wireless communication at high transfer rate function is stopped temporarily. When PTP data packet exchange recommences, there is notification of PTP data packet exchange recommencing using wireless communication with low power consumption. The wireless communication apparatus 102 and digital camera 101 IEEE802.11b-standard wireless communication at high transfer rate function is then activated. Such an arrangement can be implemented with ease.

Thus, as described above, after establishment of IEEE802.11b-standard wireless connection at high transfer rate, power consumption by wireless communication between the wireless communication apparatus 102 and the digital camera 101 can be further reduced.

In addition, when the IEEE802.11b-standard wireless communication at high transfer rate function is started in step S109 and step S207, the wireless communication with low power consumption function may be stopped.

It should be noted that, when the wireless communication apparatus 102 is connected to the computer 100, the following control can also be easily carried out: First, when searching for the digital camera 101 in step S103, for example, a search for a printer may also be conducted at the same time. Then, depending on the device that is detected in step S103, the value for the device class of the descriptor information that is set in step S105 may be changed. Specifically, when the digital camera 101 is detected USB Still Image class device descriptor information is set, and when the printer is detected USB Printer class device descriptor information is set. Thus, at the computer 100 to which the wireless communication apparatus 102 is USB-connected, according to the descriptor information the appropriate driver can be loaded or the appropriate application can be started. Further, by changing the operation of the protocol converter 108 depending on the detected device, it is possible for the computer 100 to implement operation by wireless connection to a plurality of different devices through a single wireless communication apparatus 102. For example, the computer 100 can implement operation by wireless connection to the digital camera 101 through the wireless communication apparatus 102, as well as operation by wireless connection to the printer.

### Second Embodiment

Next, a second embodiment of the present invention will now be described while referring to the drawings.

The wireless communication apparatus of the first embodiment is equipped with two types of wireless communication functions: A ZigBee-specification or other such wireless communication with low power consumption function, and an IEEE802.11b-standard or other such wireless communication at high transfer rate function. By contrast, the wireless communication apparatus of the second embodiment is equipped only with an IEEE802.11b-standard wireless communication at high transfer rate function, and this wireless communication function is equipped with a low power consumption operation mode and a high power consumption operation mode. It should be noted that the configuration of the wireless communication system of the second embodiment is the same as that shown in FIG. 1 or FIG. 2, and therefore a description thereof is omitted. However, the detailed configuration of the wireless communication apparatus 102 and the digital camera 101 differs from that shown in FIG. 3 of the first embodiment. In addition, the second embodiment is described using the example of a wireless communication system having the structure shown in FIG. 2.

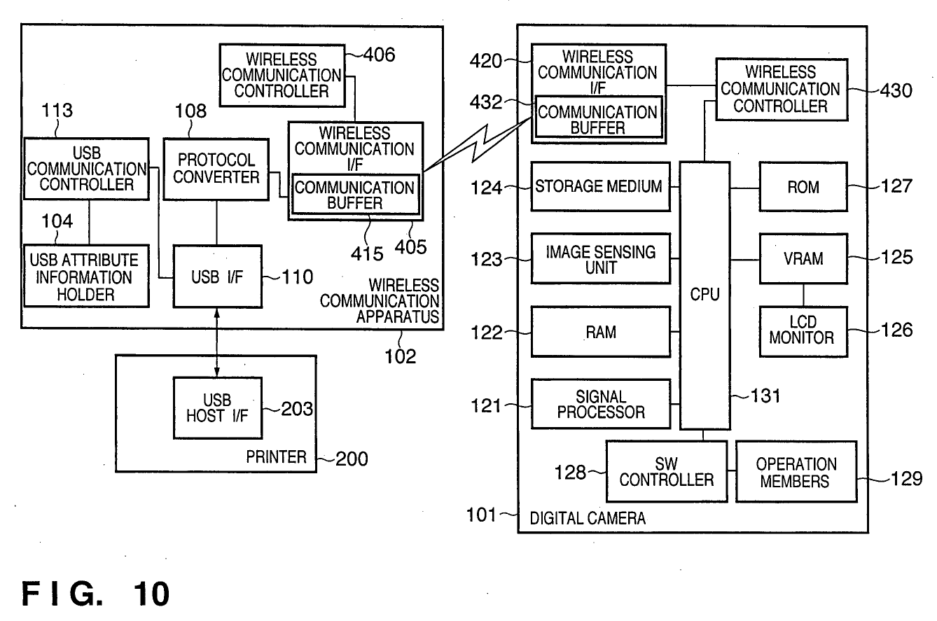

FIG. 10 is a block diagram showing the overall configuration of mainly the wireless communication apparatus 102 and the digital camera 101 according to the second embodiment of the present invention, in a communication system having the configuration shown in FIG. 2. It should be noted that elements that are identical to elements of the configuration shown in FIG. 3 are given identical reference numerals and a description thereof omitted.

In the configuration shown in FIG. 10, the wireless communication apparatus 102 is connected to the printer 200 by USB-standard communication, with communication implemented by the wireless communication apparatus 102 acting as the USB device and the printer 200 acting as the USB host.

The wireless communication apparatuses 102 and the digital cameras 101 shown in FIG. 3 and FIG. 10 differ in that those in FIG. 10 do not have the wireless communication with low power consumption I/Fs 109 and 133 and the wireless communication with low power consumption controllers 107 and 134. In addition, the wireless communication I/F 405 of the wireless communication apparatus 102 of the second embodiment and the wireless communication I/F 420 of the digital camera 101 of the second embodiment have a low power consumption mode in which they operate with low power consumption and a high power consumption mode in which they operate at high power consumption.

In wireless communication, in general, it is possible to limit the range of the radio waves by dropping transmission power while simultaneously reducing power consumption when transmitting. In addition, when receiving, the average power consumption can be reduced by operating intermittently. The wireless communication apparatus 102 of the second embodiment implements the low power consumption mode by using these techniques. In addition, in a state in which the wireless communication function in the low power consumption mode is rendered effective, the wireless communication apparatus 102 as a whole limits the usable current to 100 mA or less which is the maximum usable current before the USB device configuration (the functional structure) is specified from the USB host.

Wireless communication operation in the low power consumption mode is used mainly when the wireless communication apparatus 102 and the digital camera 101 are detecting each other's existence. Specifically, when the wireless communication apparatus 102 is searching for the digital camera 101 on a wireless network, and conversely, when the digital camera 101 is searching for the wireless communication apparatus 102 on the wireless network, they use the low power consumption mode. Particularly when the wireless communication apparatus 102 is connected to the printer 200, searching can continue-for an extended period of time until the wireless communication apparatus 102 is wirelessly connected to the digital camera 101, and therefore power consumption can be reduced by using wireless communication with low power consumption.

The packet structures of the wireless data packets that are exchanged between the wireless communication apparatus 102 and the digital camera 101 are the same as that shown in FIG. 4. As with the first embodiment, data packets of a format that is defined by PTP (Picture Transfer Protocol) are contained therein as user data.

Next, communication control in the second embodiment in the wireless communication system having the configuration described above will be described.

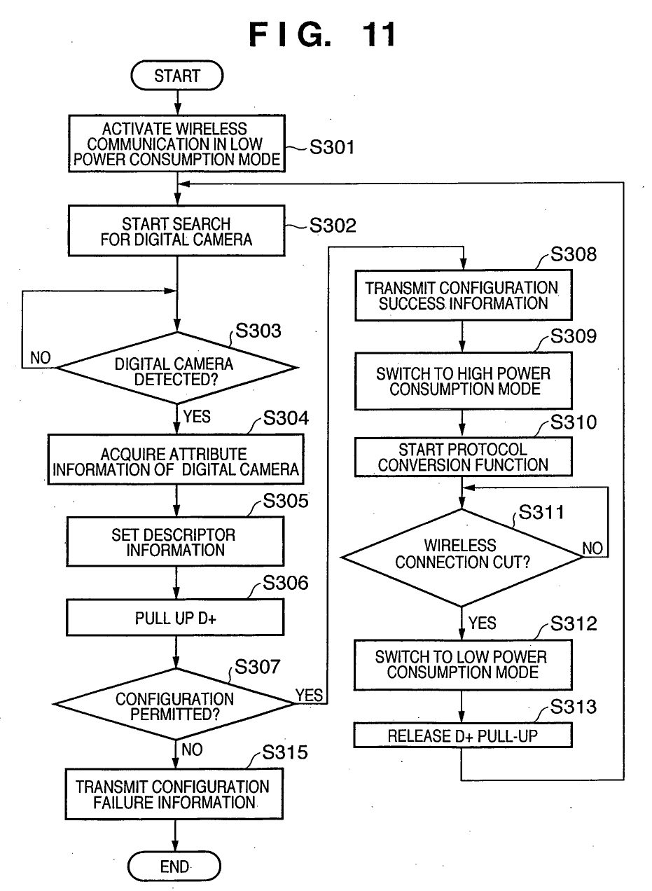

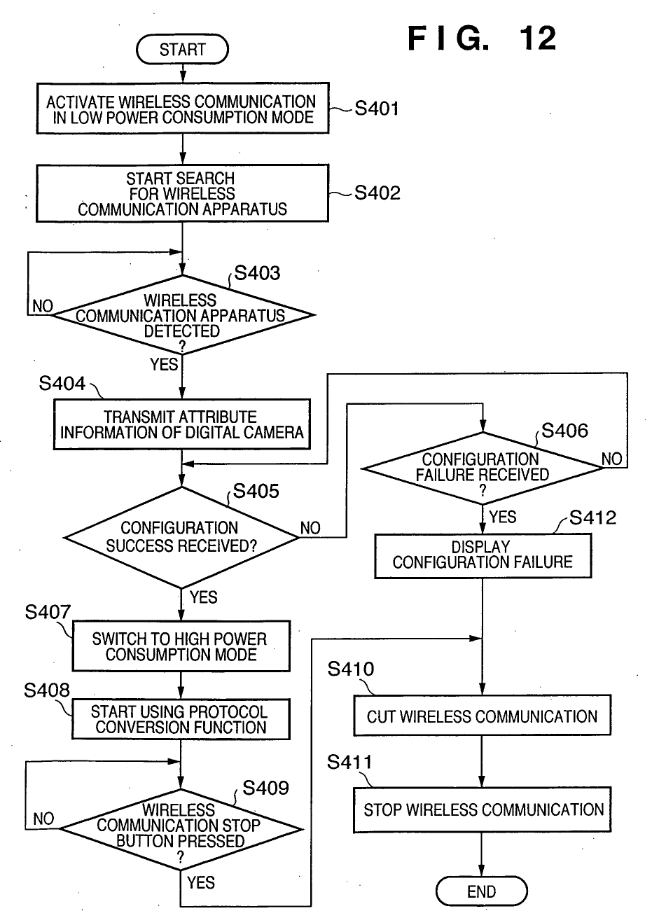

FIG. 11 and FIG. 12 are flow charts illustrating sequences of connecting and disconnecting wireless communication in the wireless communication apparatus 102 and the digital camera 101, respectively.

First, a sequence of wireless communication connection and disconnection of the wireless communication apparatus 102 will be described, with reference to FIG. 11.

When the USB I/F 110 is connected to the USB I/F 203 of the printer 200, the wireless communication apparatus 102 of the present embodiment detects voltage across the USB terminal V-bus and starts to operate. The wireless communication apparatus 102 operates with a supply of power of +5V from the USB host.

As described above, until the configuration (the functional structure) of the USB device is specified from the USB host, the wireless communication apparatus 102 must operate in a power consumption mode of maximum current 100 mA or less. In the second embodiment, the wireless communication apparatus 102 starts the wireless communication in the low power consumption mode (step S301) and starts to search for the digital camera 101 (step S302). The search for the digital camera 101 can be carried out by repeatedly transmitting at regular intervals some sort of probe signal from the wireless communication apparatus 102 and determining whether or not there is a return response thereto. Alternatively, this search can also be implemented by the digital camera 101 continuously transmitting a beacon signal that is monitored at regular intervals. It should be noted that, during the search for the digital camera 101, the clock supply to the protocol converter 108 and the USB communication controller 113 is stopped.

Generally, in wireless communication, reception consumes less power than transmission, and therefore in the second embodiment an arrangement in which the digital camera 101 periodically transmits a beacon signal that the wireless communication apparatus 102 detects is preferable. Adopting such an arrangement enables power consumption by the wireless communication apparatus 102 in the search state to be reduced.

In addition, in order to conduct IEEE802.11b-standard wireless communication, the wireless communication settings of the wireless communication apparatus 102, such as the wireless channel to be used, the ESS-ID, WEP Key and the like, must be same as those for the digital camera 101 that is the connection partner. In the second embodiment, between the wireless communication apparatus 102 and the digital camera 101, these wireless settings are set the same in advance. The wireless communication apparatus 102 is assumed to be capable of retaining the wireless setting information, which has the advantage of enabling wireless connection between the digital camera 101 and any given printer 200.

Next, when the wireless communication apparatus 102 detects the existence of the digital camera 101 (YES in step S303), it acquires attribute information of the digital camera 101 through the wireless communication I/F 405 while remaining in the low power consumption mode (step S304). Then, based on the attribute information acquired in step S304, the wireless communication apparatus 102 sets the USB descriptor information (step S305). The descriptor information contains information indicating the type of device defined by USB standard (the device class), the device name, Product ID, power consumption information and the like. Thus, by setting the descriptor information based on the attribute information of the digital camera 101 acquired using wireless communication, it is possible to load the appropriate driver in the printer 200 to which the wireless communication apparatus 102 is USB-connected. In addition, the correct digital camera name can be displayed to the user.

It should be noted that, in the second embodiment, when the wireless communication apparatus 102 acquires the attribute information of the digital camera 101, it sets the USB Still Image class device descriptor. In other words, after the digital camera 101 is detected, the wireless communication apparatus 102 behaves like a USB Still Image class device to the printer 200.

Next, after starting clock supply to the USB communication controller 113, one of the USB signal lines (the D− signal line for a Low Speed device or the D+ signal line for a Full Speed device) is pulled up to 3.3V (step S306). This operation causes the printer 200, which is the USB host, to recognize the wireless communication apparatus 102 and start USB communication. In USB communication, first, a negotiation is executed between the printer 200, which is the USB host, and the wireless communication apparatus 102, which is the USB device.

In this negotiation, information relating to the USB device configuration (functional structure) is transmitted from the USB device to the USB host and the USB host determines whether or not to permit USB connection with that configuration. If as a result of that determination connection is permitted, the USB device configuration is specified from the USB host. The configuration data contains a required current value information (MaxPower) field showing the amount of current that the USB device requires during normal operation. With the wireless communication apparatus 102 of the second embodiment, 500 mA is written as the MaxPower field value. After the configuration is specified from the USB host, the wireless communication apparatus 102 activates the wireless communication I/F 405 and the wireless communication controller 406 in the high power consumption mode and the wireless communication with the digital camera 101 in a normal mode is carried out, as a result of which, after the digital camera 101 is detected, several hundred mA of current is uninterruptedly supplied from the USB host.

If a configuration failure instruction (that is, the configuration value is zero) is generated from the USB host (NO in step S307), that information is transmitted to the digital camera 101 by wireless communication in the low power consumption mode (step S315). The digital camera 101 takes this information and displays it on the LCD monitor 126 as configuration failure information or the like, enabling the user to be notified of a connection failure.

On the other hand, if a configuration instruction (that is, the configuration value is an appropriate value other than zero) is generated from the USB host (YES in step S307), the sequence proceeds to step S308. In step S308, clock supply to the protocol converter 108 is started and configuration success information is transmitted to the digital camera 101 using wireless communication in step S308. Further, in step S309 the wireless communication function is switched to the high power consumption mode.

In addition, when a configuration instruction from the USB host is generated in step S307, the wireless communication apparatus 102 starts to behave as a Still Image class USB device toward the printer 200. In response, the operation of the Still Image class driver installed in the printer 200 generates a PTP operation. The wireless communication apparatus 102 retains the received PTP operation phase data internally and, after starting a conversion program in step S310 to be described later, transmits the PTP operation phase data to the digital camera 101.

In step S310 the wireless communication apparatus 102 starts to execute the conversion program. At this stage, the digital camera 101 and the printer 200 are connected via the wireless communication apparatus 102. When viewed from the digital camera 101, it appears to be communicating with the printer 200 by IEEE802.11b-standard wireless communication. By contrast, when viewed from the printer 200, it appears as if a Still Image class USB device is connected to the USB host I/F 203, with which it exchanges data packets in a format that is determined by PTP.

Specifically, in accordance with the PTP operation phase data that is sent from the printer 200, the digital camera 101 transmits and receives data phase data, transmits response data, and so forth, enabling image data stored on the storage medium 124 of the digital camera 101 to be transmitted to the printer 200, and printed.

Simultaneous with the execution of the protocol conversion function in step S310, in step S311 monitoring is started to determine whether or not the wireless connection has been cut. If the wireless connection has been cut, in step S312 the IEEE802.11b-standard wireless communication function is switched to the low power consumption mode. Further, in step S313, the pull up on the D+ signal line is released and the USB connection with the printer 200 is cut, after which the sequence returns to the state of step S302.

In this state, the wireless communication apparatus 102, using low power consumption mode wireless communication, recommences the search for the digital camera 101 and returns to the state of receiving a supply of 100 mA or less of current from the printer 200 that is the USB host.

In addition, when viewed from the printer 200 to which the wireless communication apparatus 102 is connected, the digital camera 101 appears to be disconnected from the USB bus and there appears to be no USB device connected to the USB bus. In this state, a maximum 100 mA of current can be supplied.

Next, a wireless communication connection and disconnection sequence in the digital camera 101 will be described, with reference to FIG. 12.

The sequence shown in FIG. 12 is started, for example, by the user instructing the start of IEEE802.11b-standard wireless communication using the operation members 129 of the digital camera 101. As described above, in order to carry out IEEE802.11b-standard wireless communication, the wireless communication settings of the digital camera 101, such as the wireless channel to be used, the ESS-ID, WEP Key and the like, must be same as those for the wireless communication apparatus 102 that is the connection partner. In the second embodiment, as described above, between the wireless communication apparatus 102 and the digital camera 101, these wireless settings are set the same in advance. In addition, the digital camera 101 is assumed to be capable of retaining the wireless setting information.

First, in step S401, the digital camera 101 activates the wireless communication function in the low power consumption mode, and in step S402 the digital camera 101 starts searching for the wireless communication apparatus 102 using wireless communication. The search for the wireless communication apparatus 102, like the search operation conducted by the wireless communication apparatus 102, can be implemented by repeatedly transmitting at regular intervals some sort of signal from the digital camera 101 and determining whether or not there is a return response thereto. Alternatively, this search can also be implemented by the wireless communication apparatus 102 continuously transmitting a beacon signal that is monitored at regular intervals.

It should be noted that, in general, in wireless communication, reception consumes less power than transmission, and therefore, in the second embodiment as described above, an arrangement in which the digital camera 101 periodically transmits a beacon signal and the wireless communication apparatus 102 detects the beacon signal is preferable. Adopting such an arrangement enables power consumption by the wireless communication apparatus 102 in the search state to be reduced.

Once the existence of the wireless communication apparatus 102 is detected (YES in step S403), the digital camera 101 transmits the attribute information of the digital camera 101 to the wireless communication apparatus 102 via the wireless communication I/F 405 in the low power consumption mode (step S404).

Thereafter, in step S405, the wireless communication apparatus 102 waits for configuration success information to be transmitted from the digital camera 101 on the wireless communication transmission path. While waiting for the configuration success information (in other words, as long as NO in step S405), in step S406 it is determined whether or not configuration failure information has been transmitted from the digital camera 101 on that same transmission path.

If in step S406 configuration failure information is received, in step S412 the failure of the configuration is displayed on the LCD monitor 126 of the digital camera 101 so as to notify the user. Further, in step S410 wireless communication is cut, and in step S411 IEEE802.11b-standard wireless communication is stopped and the wireless connection sequence is ended. One cause of configuration failure can be insufficient power supply capacity on the part of the printer 200 to which the wireless communication apparatus 102 is connected. If matters are arranged so that such information is displayed as the cause of failure, then the user can take appropriate action, such as switching the printer 200 from battery power to AC power or the like.

On the other hand, when in step S405 configuration success information is received from the digital camera 101, in step S407 the wireless communication function is switched to the high power consumption mode. Then, in step S408, use of the protocol converter function that the wireless communication apparatus 102 provides starts.

In this state, if the user operates the operation members 129 of the digital camera 101 to specify a print image and instruct transmission, the specified image file can be transmitted to the printer 200 through the wireless communication apparatus 102. By then transmitting a print start request to the printer 200 through the wireless communication apparatus 102 the target image is printed at the printer 200.

Between the digital camera 101 and the wireless communication apparatus 102, PTP data packets are loaded onto TCP payloads and further converted to. IEEE802.11b-standard packets for transmission and reception by wireless communication.

Inside the digital camera 101, once an IEEE802.11b-standard packet sent from the wireless communication apparatus 102 is received, the header and so forth as defined by IEEE802.11b standard is removed. Further, in accordance with the IP header and the TCP header, the user data is extracted, and finally, the PTP operation phase data and data phase data are extracted and processed. On the other hand, when PTP data phase data and response phase data are transmitted from the digital camera 101, the PTP data packet is divided into sizes each fits into a single TCP packet, after which appropriate headers are attached. Further, the each divided packet with headers is converted into an IEEE802.11b-standard packet and transmitted by wireless communication.

While the digital camera 101 is using the protocol conversion function that the wireless communication apparatus 102 provides, in step S409 there is monitoring of the user pressing the power button or the wireless communication end button of the operation members 129. If the user presses the power button or the wireless communication end button, in step S410 the wireless connection is cut, the IEEE802.11b-standard wireless communication function is stopped and the wireless communication sequence is ended.

Thus, as described above, according to the second embodiment, where there is no impediment to communication between the printer 200 and the wireless communication apparatus 102, wireless communication is conduced in the high power consumption mode; in all other cases, wireless communication is conducted in the low power consumption mode, thereby enabling power consumption at the wireless communication apparatus 102 to be reduced.

In addition, the wireless communication apparatus 102, after it detects the existence of the digital camera 101 using IEEE802.11b-standard wireless communication in the low power consumption mode, acquires the attribute information of the digital camera 101 and sets the USB descriptor information based on the attribute information thus acquired. In addition, after the conversion program is executed, PTP data packets transmitted from the printer are transmitted to the digital camera, and moreover, PTP data packets transmitted from the digital camera are transmitted to the printer. As a result, it is not necessary for the wireless communication apparatus 102 to respond in place of a digital camera 101 or to reply with temporary information to requests in the form of PTP data packets or USB data packets from the USB host, and therefore discrepancies in the information exchanged between the USB host and the digital camera 101 can be prevented from occurring.

In addition, since the digital camera 101 and the wireless communication apparatus 102 of the second embodiment are provided with a low power consumption mode and a high power consumption mode for the wireless communication function, there is no need to provide a separate low power consumption wireless communication function as is the case with the first embodiment. Therefore, there is no need to install a low power consumption-chip, thus enabling the wireless communication apparatus 102 and the digital camera 101 to be manufactured inexpensively.

Although the wireless communication between the wireless communication apparatus 102 and the digital camera 101 of the second embodiment is described in terms of an embodiment using IEEE802.11b-standard wireless communication, the present invention is not limited to such an arrangement. Thus, for example, the present invention can be implemented by replacing the IEEE802.11b-standard wireless communication with Bluetooth, or with the even faster IEEE802.11g- or IEEE802.11n-standard wireless communication.

Further, although in the second embodiment the wired communication function between the wireless communication apparatus 102 and the printer 200 is implemented by USB-standard wired communication, it is of course possible to use wired communication that conforms to other wired communication standards instead.

In addition, if the wireless communication apparatus 102 of the second embodiment is connected to the computer 100, the computer 100 can be controlled as follows: After it is detected that a USB device has been attached to the USB host terminal, the circuits and parts for processing image data, as well as the circuits and so forth for conducing USB communication, are activated. According to the wireless communication apparatus 102 of the second embodiment, while searching for the digital computer 100 the D+ signal line is not pulled up, and therefore the computer 100, which is the USB host, is not allowed to recognize the wireless communication apparatus 102. Since the search for the digital camera 101 can continue for an extended period of time, power consumption on the computer 100 side during that time can be effectively reduced.

In addition, in the second embodiment described above, a system composed of the printer 200 that does not have a wireless communication function, the wireless communication apparatus 102 and the digital camera 101 that does have a wireless communication function is used. However, the present invention is not limited thereto, and it is of course possible to use any device that does not have a wireless communication function in place of the printer 200, as well as any device that does have a wireless communication function in place of the digital camera 101.

In the above-described first and second embodiments, the wireless communication apparatus 102 operates on a supply of power received from the USB host. However, the wireless communication apparatus 102 itself may be provided with a battery or other such power supply means, and operate as a self-powered device without receiving a supply of power from the USB host. In that case, the wireless communication apparatus 102 can operate without regard to limits on the amount of power that can be supplied from the USB host. In-addition, in this case, there is the advantage that, when the wireless communication apparatus 102 searches for the digital camera 101, wearing down of the internal battery of the wireless communication apparatus 102 can be prevented by conducting wireless communication with low power consumption.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-298099, filed on Oct. 12, 2005, which is hereby incorporated by reference herein in its entirety.

What is claimed is:

1. A wireless communication apparatus that converts data received by wired communication from an external apparatus and transmits the converted data by wireless communication to an external wireless communication apparatus, and converts data received by wireless communication from said external wireless communication apparatus and transmits the converted data by wired communication to the external apparatus, said wireless communication apparatus comprising:
a transceiver unit that transmits data to and receives data from said external apparatus by wired communication;
a first wireless communication unit;
a second wireless communication unit that operates on power consumption lower than that of said first wireless communication unit; and
a control unit that controls to detect said external wireless communication apparatus using said second wireless communication unit and communicate with said external wireless communication apparatus using said first wireless communication unit if said external wireless communication apparatus is detected.

2. The wireless communication apparatus according to claim 1, wherein the wireless communication apparatus changes settings of attribute information for said transceiver unit depending on said external wireless communication apparatus detected by said second wireless communication unit.

3. The wireless communication apparatus according to claim 1, further comprising an activation unit that activates said transceiver unit during communication with said external wireless communication apparatus using said first wireless communication unit and de-activates said transceiver unit during all other times.

4. The wireless communication apparatus according to claim 1, wherein said transceiver unit operates on power supplied by said external apparatus.

5. The wireless communication apparatus according to claim 1, wherein said transceiver unit transmits and receives USB-standard protocol data and is connected as a USB device to said external apparatus.

6. The wireless communication apparatus according to claim 5, wherein said transceiver unit, depending on said external wireless communication apparatus, changes a value of at least one field of USB descriptor information.

7. A wireless communication apparatus that converts data received by wired communication from an external apparatus and transmits the converted data by wireless communication to an external wireless communication apparatus, and converts data received by wireless communication from said external wireless communication apparatus and transmits the converted data by wired communication to said external apparatus, said wireless communication apparatus comprising:
a transceiver unit that transmits data to and receives data from said external apparatus by wired communication;
a wireless communication unit capable of operating in a first communication mode and in a second communication mode that operates on power consumption lower than that of said first communication mode; and
a control unit that controls said wireless communication unit to detect said external wireless communication apparatus in said second communication mode and communicate with said external wireless communication apparatus in said first communication mode if said external wireless communication apparatus is detected.

8. The wireless communication apparatus according to claim 7, wherein said wireless communication apparatus changes settings of attribute information for said transceiver unit depending on said external wireless communication apparatus detected in said second communication mode.

9. The wireless communication apparatus according to claim 7, further comprising an activation unit that activates said transceiver unit during communication in said first communication mode with said external wireless communication apparatus and de-activates said transceiver unit during all other times.

10. The wireless communication apparatus according to claim 7, wherein said transceiver unit operates on power supplied by said external apparatus.

11. The wireless communication apparatus according to claim 7, wherein said transceiver unit transmits and receives USB-standard protocol data and is connected as a USB device to said external apparatus.

12. The wireless communication apparatus according to claim 7, wherein said transceiver unit, depending on said external wireless communication apparatus, changes a value of at least one field of USB descriptor information.

13. A control method for a wireless communication apparatus having a transceiver unit that transmits data to and receives data from said external apparatus by wired communication, a first wireless communication unit and a second wireless communication unit that operates on power consumption lower than that of said first wireless communication unit, said wireless communication apparatus converting data received by wired communication from an external apparatus and transmitting the converted data by wireless communication to an external wireless communication apparatus as well as converting data received by wireless communication from said external wireless communication apparatus and transmitting the converted data by wired communication to said external apparatus, said wireless communication apparatus control method comprising:
a detection step of detecting said external wireless communication apparatus using said second wireless communication unit; and
a control step of controlling to communicate with said external wireless communication apparatus using said first wireless communication unit if said external wireless communication apparatus is detected in said detection step.

14. The control method according to claim 13, further comprising a step of changing settings of attribute information for said transceiver unit depending on said external wireless communication apparatus detected by said second wireless communication unit.

15. The control method according to claim 13, further comprising an activation step of activating said transceiver unit during communication with said external wireless communication apparatus using said first wireless communication unit and de-activating said transceiver unit during all other times.

16. The control method according to claim 13, wherein said transceiver unit operates on power supplied by said external apparatus.

17. The control method according to claim 13, wherein said transceiver unit transmits and receives USB-standard protocol data and is connected as a USB device to said external apparatus.

18. The control method according to claim 13, wherein said transceiver unit changes a value of at least one field of USB descriptor information depending on said external wireless communication apparatus.

19. A control method for a wireless communication apparatus having a transceiver unit that transmits data to and receives data from said external apparatus by wired communication and a wireless communication unit capable of operating in a first communication mode and in a second communication mode that operates on power consumption lower than that of said first communication mode, said wireless communication apparatus converting data received by wired communication from an external apparatus and transmitting the converted data by wireless communication to an external wireless communication apparatus as well as converting data received by wireless communication from said external wireless communication apparatus and transmitting the converted data by wired communication to the external apparatus, said wireless communication apparatus control method comprising:
a detection step of detecting said external wireless communication apparatus in said second communication mode; and
a control step of causing said wireless communication unit to detect said external wireless communication apparatus in said second communication mode and communicate with said external wireless communication apparatus in said first communication mode if said external wireless communication apparatus is detected.

20. The control method according to claim 19, further comprising a step of changing settings of attribute information for said transceiver unit depending on said external wireless communication apparatus detected in said second communication mode.

21. The control method according to claim 19, further comprising an activation step of activating said transceiver unit during communication with said external wireless communication apparatus in said first communication mode and de-activating said transceiver unit during all other times.

22. The control method according to claim 19, wherein said transceiver unit operates on power supplied by said external apparatus.

23. The control method according to claim 19, wherein said transceiver unit transmits and receives USB-standard protocol data and is connected as a USB device to said external apparatus.

24. The control method according to claim 19, wherein said transceiver unit changes a value of at least one field of USB descriptor information depending on said external wireless communication apparatus.
